(19) United States
(12) Patent Application Publication
(10) Pub. No.: US 2026/0135739 A1
(43) Pub. Date: May 14, 2026

(54) DECISION FEEDBACK EQUALIZED RECEIVER MONITOR CIRCUITRY CALIBRATION

(71) Applicant: Rambus Inc., San Jose, CA (US)

(72) Inventors: Kumail Khozema KHURRAM, Karnataka (IN); Divanshu CHATURVEDI, Karnataka (IN)

(21) Appl. No.: 19/370,439

(22) Filed: Oct. 27, 2025

Related U.S. Application Data
(60) Provisional application No. 63/720,331, filed on Nov. 14, 2024.

(51) Int. Cl. H04L 25/03

(52) U.S. Cl. CPC H04L 25/03057

(57) ABSTRACT

A receiver includes variable gain analog front-end (AFE) circuitry, a main sampler, and a monitor sampler. The gain of the AFE circuitry is controlled by a gain indicator provided by control circuitry. The threshold voltage of the monitor sampler is provided by a digital-to-analog converter (DAC) having a controllable step size. A calibration sequence is used to search for step size settings that, for various gain indicator values, reproduce or approximate a baseline threshold voltage of the main sampler at a baseline gain setting. The relationships between these step size settings and gain indicator values may be used to ensure a close relationship between the threshold of the main sampler and the threshold of the monitor sampler over a range of gain settings.

### BRIEF DESCRIPTION OF THE DRAWINGS

FIG. 1 is a diagram illustrating an integrated circuit.

FIG. 2 is a diagram illustrating a communication system with decision feedback equalization (DFE).

FIG. 3 is a diagram illustrating a memory system.

FIG. 4 is a flowchart illustrating a method of operating an integrated circuit.

FIG. 5 is a flowchart illustrating a method of calibrating monitor circuitry.

FIG. 6 is a flowchart illustrating a method of setting a plurality of monitor sampler reference voltage digital-to-analog converter set sizes.

FIG. 7 is a block diagram of a processing system.

### DETAILED DESCRIPTION OF THE EMBODIMENTS

Decision feedback equalization (DFE) is used to help reduce inter-symbol interference (ISI) from a data signal received via a band-limited (or otherwise non-ideal) channel. Additional equalization may also be applied to an input signal using analog front-end (AFE) circuitry with, for example, a continuous-time linear equalizer (CTLE) and/or a variable gain circuitry (e.g., a variable gain amplifier—VGA). Signal eye monitoring at a receiver using DFE may be used to help determine DFE coefficients thereby improving ISI correction.

In an embodiment, a receiver includes variable gain AFE circuitry, DFE circuitry, a main sampler, and a monitor sampler. The gain of the AFE circuitry is controlled by a gain indicator provided by control circuitry. The main sampler and the monitor sampler sample a node where the input signal is summed with the DFE tap outputs (summing node). The threshold voltage of the monitor sampler is provided by a digital-to-analog converter (DAC) having a controllable step size (i.e., the voltage/current change per unit input value change is controllable). A calibration sequence is used to search for step size settings that, for various gain indicator values, reproduce or approximate a baseline threshold voltage of the main sampler at a baseline gain setting. The relationships between these step size settings and gain indicator values may be used to ensure a close relationship between the threshold of the main sampler and the threshold of the monitor sampler over a range of gain settings.

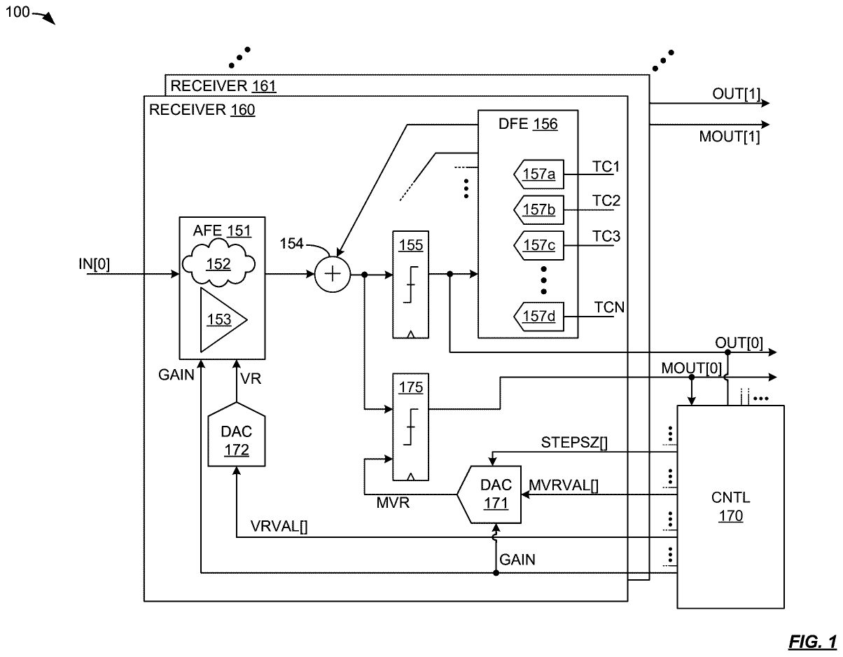

FIG. 1 is a diagram illustrating an integrated circuit. Integrated circuit 100 includes a plurality of receiver circuits 160-161 and control circuitry 170 (e.g., a finite state machine - FSM). In FIG. 1, receiver circuitry 160 and receiver circuitry 161 (and other receivers not shown in FIG. 1) are both calibrated, at least in part, by control circuitry 170. In addition, receiver circuit 160 and receiver circuit 161 are, with the exception of being provided different input signals (e.g., data, control, calibration, etc.) and producing different output signals (because of being provided with different input signals) functionally identical and therefore, for the sake of brevity, only receiver circuitry 160 is, for the most part, illustrated and discussed herein.

Receiver circuitry 160 (and by extension receiver circuit 161 and other receiver circuits) comprises AFE circuitry 151, summer 154, main sampler 155, DFE circuitry 156, monitor reference (threshold) voltage digital-to-analog converter (DAC) 171, reference voltage DAC 172, and monitor sampler 175. AFE circuitry 151 may include analog circuitry 152 (e.g., CTLE circuitry) and/or variable gain (or attenuation) circuitry 153 (e.g., VGA circuitry). In an embodiment, variable gain circuitry 153 may be, comprise, or function as a differential amplifier. DFE circuitry 156 includes tap value DACs 157a-157d. Tap value DACs 157a-157d respectively receive tap codes TC1, TC2, TC3, and TCN representing N number of DFE taps implemented by DFE circuitry 156.

AFE circuitry 151 of receiver circuit 160 receives input signal IN[0] (e.g., from another integrated circuit—not shown in FIG. 1), receiver reference voltage VR, and a gain indicator GAIN. Receiver reference voltage VR is produced by reference voltage DAC 172 based on a multi-bit digital value VRVAL[] received from, and controlled by, control circuitry 170. In an embodiment, to produce an output signal that is provided to summer 154, AFE circuitry 151 may equalize the input signal IN[0] using analog circuitry 152. In an embodiment, to produce its output signal that is provided to summer 154, AFE circuitry 151 may amplify or attenuate (e.g., using variable gain circuitry 153) the input signal IN[0] in relation to its difference with reference voltage VR and that difference amplified (or attenuated) by a variable gain amount that is based on gain indicator GAIN. In an embodiment, to produce its output signal that is provided to summer 154, AFE circuitry 151 may both equalize the input signal IN[0] and amplify or attenuate the input signal IN[0] (or other internal signal—e.g., the output of CTLE 153) in relation to its difference with reference voltage VR and that difference amplified (or attenuated) by a variable gain amount that is based on gain indicator GAIN.

The output of AFE circuitry 151 is provided to summer 154. Summer 154 also receives, from DFE circuitry 156, post-cursor ISI removal signals that are, based on corresponding tap codes TC1-TCN, adapted and/or selected to remove post-cursor ISI components from the output of AFE circuitry 151. For example, tap code TC1 may be adapted so that the output of DAC 157a, when combined with (e.g., multiplied by) the first-post cursor sampled value, removes the first post-cursor ISI component from the output of AFE circuitry 151. Similarly, for example, tap code TC2 may be adapted so that the output of DAC 157b, when combined with (e.g., multiplied by) the second-post cursor sampled value, removes the second post-cursor ISI component from the output of AFE circuitry 151, and so on for the additional post-cursor components removed by DFE circuitry 156. The output of summer 154 is provided to signal input of main sampler 155 and the signal input of monitor sampler 175. The output of main sampler 155 is also the output of receiver circuitry 160OUT[0].

The threshold voltage of monitor sampler 175 is determined by monitor reference voltage MVR. Monitor reference voltage MVR is produced by monitor sampler reference voltage DAC 171 based on a multi-bit digital value MVRVAL[] received from, and controlled by, control circuitry 170. Monitor reference voltage also receives, from control circuitry 170, the gain indicator GAIN and a multi-bit digital value STEPSZ[] that controls the step size accorded the input value MVRVAL[]. In other words, the voltage change (ΔV) produced by DAC 171 in response to a change in the value of the least significant bit of MRVAL[] is controlled by the value of STEPSZ[]. In an embodiment, since MVRVAL[] has a minimum and maximum range of values, STEPSZ[] may also control the maximum (or minimum) value output by DAC 171.

In an embodiment, control circuitry 170 sets a default GAIN indicator (e.g., 0 dB gain), sweeps VRVAL[] through a range of values, and monitors OUT[0] during the sweep to determine a VRVAL[] value associated with OUT[0] transitioning from one state to another. This VRVAL[] value is referred to herein as a main sampler edge transition value.

For example, with the GAIN indicator set to 0 dB, control circuitry 170 may sweep VRVAL[] from a minimum voltage producing value to a maximum voltage producing value (or other range). As VRVAL[] is swept from this minimum to this maximum (and therefore VR is swept from a minimum value to a maximum), control circuitry 170 may monitor OUT[0] to detect which value(s) of VRVAL[] delineate the transition from, for example, a logical “1” to a logical “0”. The linear sweeping of VRVAL[] is merely one example search algorithm for the main sampler edge transition value. Other search algorithms (e.g., sweeping from high to low, binary search, etc.) to measure the main sampler edge transition value for VRVAL[] are contemplated.

Control circuitry 170 sets an initial GAIN indicator setting (e.g., −6 dB gain), sweeps MVRVAL[] through a range of values, and monitors MOUT[0] during the sweep to determine a MVRVAL[] value associated with MOUT[0] transitioning from one state to another. This MVRVAL[] value is referred to herein as a monitor sampler edge transition value.

For example, control circuitry 170 may then set an initial GAIN indicator setting (e.g., −6 dB) and an initial step size value (e.g., minimum STEPSZ[] value). Control circuitry may then sweep MVRVAL[] from a minimum voltage producing value to a maximum voltage producing value (or other range). As MVRVAL[] is swept from this minimum to this maximum (and therefore MVR is swept from a minimum value to a maximum), control circuitry 170 may monitor MOUT[0] to detect which value(s) of MVRVAL[] delineate the transition from, for example, a logical “1” to a logical “0”. The linear sweeping of MVRVAL[] is merely one example search algorithm for a current monitor sampler edge transition value. Other search algorithms (e.g., sweeping from high to low, binary search, etc.) to measure a monitor sampler edge transition value for MVRVAL[] are contemplated.

After determining a monitor sampler transition value for a given set of settings (e.g., gain, DAC 171 step size, etc.), control circuitry 170 compares the monitor sampler edge transition value for that set of settings with the main sampler edge transition value. If the monitor sampler edge transition value for that set of settings is equal to the main sampler edge transition value, control circuitry 170 associates the current STEPSZ[] value with the current GAIN indicator and stores that association.

If the monitor sampler edge transition value for that set of settings is not equal to the main sampler edge transition value, control circuitry selects a new STEPSZ[] value (e.g., increments, decrements, etc. as part of a sweep or search algorithm for STEPSZ[]), and repeats the sweep of MVRVAL[] through the range of values, and monitors MOUT[0] during the sweep to determine a new MVRVAL[] value, based on the new STEPSZ[] setting, associated with MOUT[0] transitioning from one state to another. Control circuitry 170 then compares the new (a.k.a. current) monitor sampler edge transition value for that set of settings with the main sampler edge transition value. If the monitor sampler edge transition value for that set of settings is equal to the main sampler edge transition value, control circuitry 170 associates the current STEPSZ[] value with the current GAIN indicator and stores that association.

If the monitor sampler edge transition value for the current of settings is not equal to the main sampler edge transition value, control circuitry then selects a new STEPSZ[] value. This process of searching for a STEPSZ[] value that results in a monitor sampler edge transition value for that set of settings that is equal to the main sampler edge transition value is repeated until a STEPSZ[] value that results in a monitor sampler edge transition value for that set of settings that is equal to the main sampler edge transition value is found.

After a STEPSZ[] value that results in a monitor sampler edge transition value for that set of settings that is equal to the main sampler edge transition value is found for a particular GAIN setting, a new GAIN setting is selected and the processes described herein are repeated until all of the GAIN settings (or at least those GAIN setting of interest to control circuitry 170) are associated with a STEPSZ[] value that results in a monitor sampler edge transition value for that set of settings that is equal to the main sampler edge transition value.

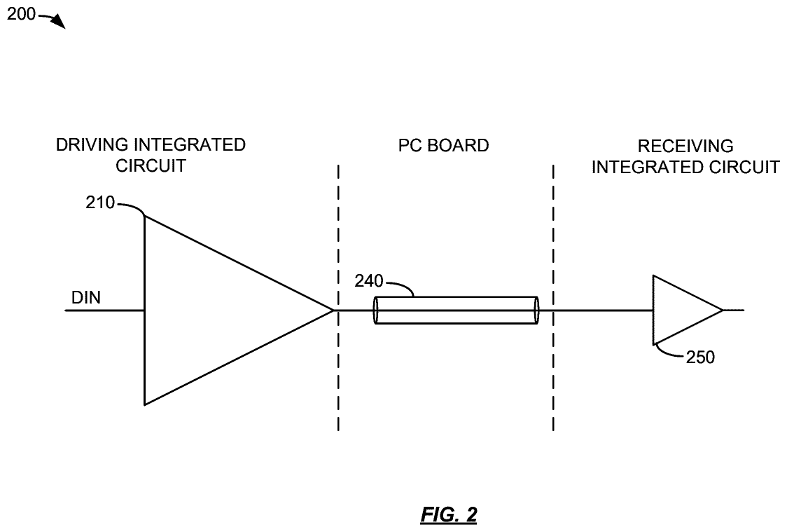

FIG. 2 is a diagram illustrating a communication system with decision feedback equalization (DFE). Communication system 200 comprises a driving integrated circuit, a receiving integrated circuit, and interconnect between them. The driving integrated circuit includes transmitter circuit 210 (a.k.a., a driver). Transmitter circuit 210 may use finite impulse response (FIR) based equalization.

The receiver integrated circuit includes receiver circuitry 250. Receiver circuitry 250 may be, or comprise, receiver circuitry 160 and/or receiver circuitry 161. The interconnect between the driving integrated circuit and the receiving integrated circuit comprises interconnect system 240. Interconnect system 240 would typically comprise a printed circuit (PC) board, connector, cable, flex circuit, other substrate, and/or a combination of these. Interconnect system 240 may be and/or include one or more transmission lines.

Receiver circuitry 250 would typically be part of an integrated circuit that is receiving the signal sent by the driving integrated circuit. It should be understood that termination (not shown in FIG. 2) can be part of the integrated circuit or interconnect system 240. It should also be understood that although system 200 is illustrated as transmitting a single-ended signal, the signals sent by the driving integrated circuit of system 200 may represent one of a pair of differential signals or one of a collection of signals sending multi-wire-coded data.

In FIG. 2, the output of transmitter circuit 210 is connected to a first end of interconnect system 240. The second end of interconnect system 240 is connected to the input of receiver circuitry 250. In an embodiment, transmitter circuit 210 may be configured to drive PAM-4 signaling levels. In another embodiment, transmitter circuit 210 may be configured to drive PAM-2 (non-return to zero—NRZ) signaling levels.

In an embodiment, the receiving integrated circuit (and receiver circuitry 250, in particular) may include receiver circuitry 250 to receive an input signal from interconnect system 240. Receiver circuitry 250 may comprise AFE circuitry and DFE circuitry that collectively generate a summed node signal that is the result of a summing operation, process, or effect. Receiver circuitry 250 may also comprise monitor circuitry to compare the summed node signal and a monitor reference voltage. The monitor reference voltage may be produced by a monitor reference voltage DAC with a controllable step size. Receiver circuitry 250 may also comprise control circuitry to measure a main sampler edge transition value and to search for combinations of gain settings with monitor reference voltage DAC steps sizes that result in, a measured monitor sampler edge transition values being equal to the main sampler edge transition value.

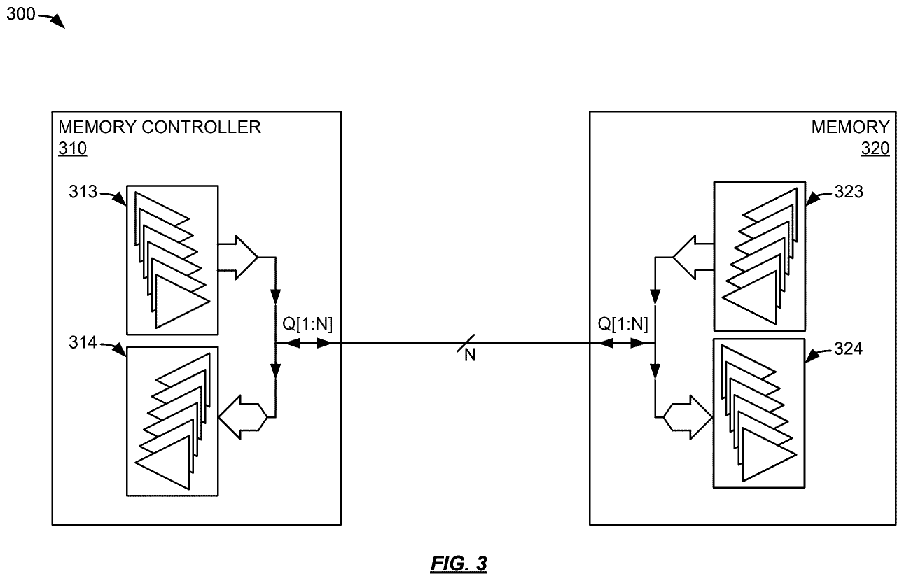

FIG. 3 is a block diagram illustrating a memory system. In FIG. 3, memory system 300 comprises memory controller 310 and memory 320. Memory controller 310 includes drivers 313 and receivers 314. Memory controller 310 also includes N number of signal ports Q[1:N] that may be driven by one or more of drivers 313 and may receive signals to be sampled by one or more of receivers 314. Memory 320 includes drivers 323 and receivers 324. Memory 320 also includes N number of signal ports Q[1:N] that may be driven by one or more of drivers 323 and may receive signals to be sampled by one or more of receivers 324. Signal ports Q[1:N] of memory controller 310 are operatively coupled to ports Q[1:N] of memory 320, respectively. Receivers 324 of memory 320 may receive one or more of the Q[1:N] signals from memory controller 310. Receivers 314 of memory controller 310 may receive one or more of the Q[1:N] signals from memory 320.

One or more of drivers 313 when configured and coupled with a corresponding one or more receivers 324 may form a PAM-2 signaling system or a PAM-4 signaling system. Thus, one or more of drivers 313 of memory controller 310 may correspond to transmitter circuit 210, discussed previously, or correspond to a transmitter circuit discussed herein subsequently. One or more of receivers 314 of memory controller 310 may correspond to receiver circuitry 160, receiver circuitry 161, and/or receiver circuitry 250, discussed previously, or correspond to a receiver circuit discussed herein subsequently. The one or more of receivers 314 of memory controller 310 may use a DFE architecture that uses the current input voltage (symbol) received via from memory 320 as an input to help determine a DFE feedback signal.

One or more of drivers 323 when configured and coupled with a corresponding one or more receivers 314 may form a PAM-2 signaling system or a PAM-4 signaling system. Thus, one or more of drivers 323 of memory 320 may correspond to transmitter circuit 210, discussed previously, or correspond to a transmitter circuit discussed herein subsequently. One or more of receivers 324 of memory 320 may correspond to receiver circuitry 160, receiver circuitry 161, and/or receiver circuitry 250, discussed previously, or correspond to a receiver circuit discussed herein subsequently. The one or more of receivers 324 of memory 320 may use a DFE architecture that uses the current input voltage (symbol) received from memory controller 310 as an input to help determine a DFE feedback signal.

Memory controller 310 and memory 320 are integrated circuit type devices, such as one commonly referred to as a “chip”. A memory controller, such as memory controller 310, manages the flow of data going to and from memory devices, such as memory 320. For example, a memory controller may be a northbridge chip, an application specific integrated circuit (ASIC) device, a graphics processor unit (GPU), a system-on-chip (SoC) or an integrated circuit device that includes many circuit blocks such as ones selected from graphics cores, processor cores, and MPEG encoder/decoders, etc. Memory 320 can include a dynamic random access memory (DRAM) core or other type of memory cores, for example, static random access memory (SRAM) cores, or non-volatile memory cores such as flash. In addition, although the embodiments presented herein describe memory controller and components, the instant apparatus and methods may also apply to chip interfaces that effectuate signaling between separate integrated circuit devices.

It should be understood that signal ports Q[1:N] of both memory controller 310 and memory 320 may correspond to any input or output pins (or balls) of memory controller 310 or memory 320 that transmit information between memory controller 310 and memory 320. For example, signal ports Q[1:N] can correspond to bidirectional data pins (or pad means) used to communicate read and write data between memory controller 310 and memory 320. The data pins may also be referred to as “DQ” pins. Thus, for a memory 320 that reads and writes data up to 16 bits at a time, signal ports Q[1:N] can be seen as corresponding to pins DQ[0:15]. In another example, signal ports Q[1:N] can correspond to one or more unidirectional command/address (C/A) bus. Signal ports Q[1:N] can correspond to one or more unidirectional control pins. Thus, signal ports Q[1:N] on memory controller 310 and memory 320 may correspond to pins such as CS (chip select), a command interface that includes timing control strobes such as RAS and CAS, address pins A[0:P] (i.e., address pins carrying address bits), DQ[0:X] (i.e., data pins carrying data bits), etc., and other pins in past, present, or future devices.

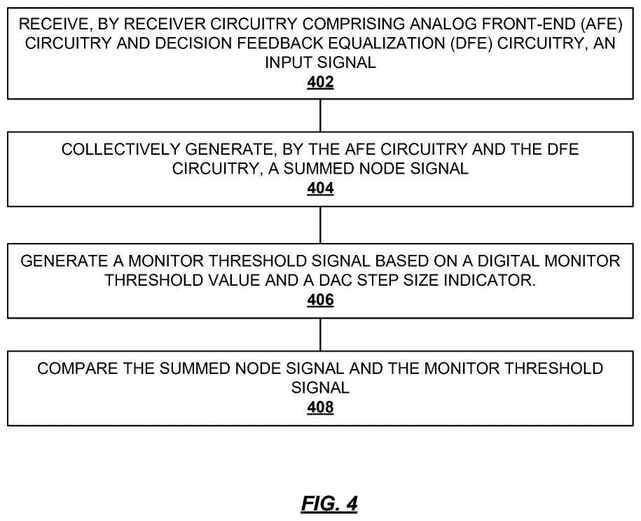

FIG. 4 is a flowchart illustrating a method of operating an integrated circuit. The steps illustrated in FIG. 4 may be performed by one or more elements of integrate circuit 100, system 200, and/or system 300. By receiver circuitry comprising analog front-end (AFE) circuitry and decision feedback equalization circuitry, an input signal is received (402). For example, receiver circuitry 160 that includes AFE circuitry 151 and DFE circuitry 156, may receive an input signal IN[0].

By the AFE circuitry and the DFE circuitry, a summed node signal is collectively generated (404). For example, the output of AFE circuitry 151 in response to the input signal IN[0], and the outputs of DFE circuitry 156 in response to post-cursor samples by main sampler 155, may be summed by summer 154 to generate an equalized signal that is provided to the data input of main sampler 155. A monitor threshold signal is generated based on a digital monitor threshold value and a DAC step size indicator (406). For example, MVR may be generated by DAC 171 based on MRVAL[] and STEPSZ[]. The summed node signal and the monitor threshold signal are compared (408). For example, during operation of integrated circuit 100, monitor sampler 175 may compare the output of summer 154 to the monitor sampler reference voltage MVR generated by variable step size monitor sampler reference voltage DAC 171.

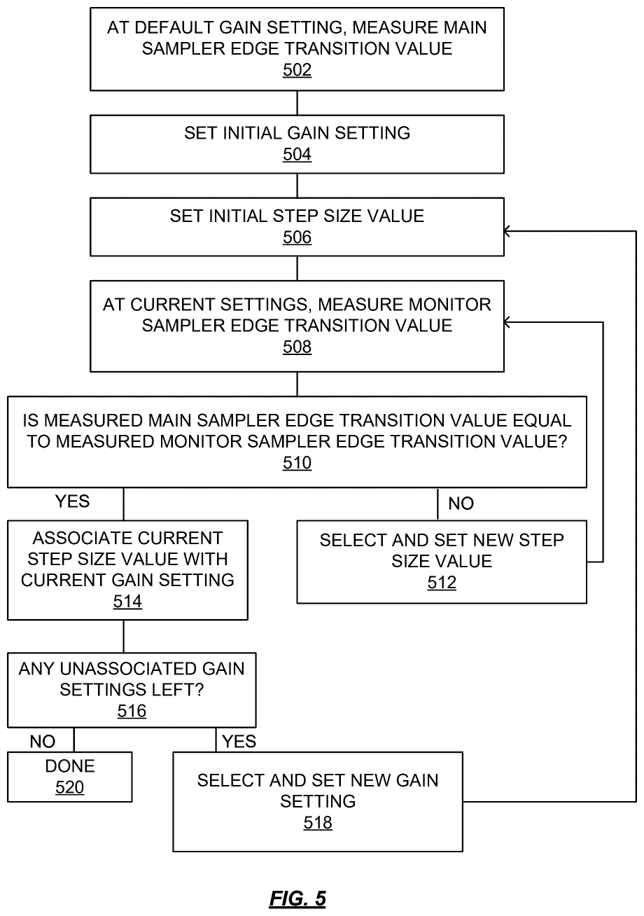

FIG. 5 is a flowchart illustrating a method of calibrating monitor circuitry. The steps illustrated in FIG. 5 may be performed by one or more elements of integrate circuit 100, system 200, and/or system 300. At a default gain setting, a main sampler edge transition value is measured (502). For example, with the GAIN indicator set to 0 dB, control circuitry 170 may sweep VRVAL[] from a minimum voltage producing value to a maximum voltage producing value (or other range) while monitoring OUT[] to detect which value(s) of VRVAL[] delineate the transition from, for example, a logical “1” to a logical “0”. The linear sweeping of VRVAL[] is merely one example search algorithm for measuring the main sampler edge transition value. For example, sweeping from high to low, binary search, and/or other known search algorithms may be used to measure the main sampler edge transition value.

An initial gain setting is set (504). For example, control circuitry 170 may set an initial GAIN indicator setting (e.g., −6 dB gain) and provide that GAIN indicator to AFE circuitry 151 and DAC 171. An initial step size value is set (506). For example, control circuitry 170 may set an initial STEPSZ[] value (e.g., the minimum STEPSZ[] value). At the current setting, a monitor sampler edge transition value is measured (508). For example, at the current setting for GAIN and STEPSZ[], control circuitry may sweep MVRVAL[] from a minimum voltage producing value to a maximum voltage producing value (or other range). As MVRVAL[] is swept from this minimum to this maximum (and therefore MVR is swept from a minimum value to a maximum), control circuitry 170 may monitor MOUT[0] to detect which value(s) of MVRVAL[] delineate the transition from, for example, a logical “1” to a logical “0”. The linear sweeping of MVRVAL[] is merely one example search algorithm for measuring the monitor sampler edge transition value. For example, sweeping from high to low, binary search, and/or other known search algorithms may be used to measure the monitor sampler edge transition value.

The measured main sampler edge transition value from block 502 is compared with the measured monitor sampler edge transition value from block 508 (510). If the measured main sampler edge transition value from block 502 is equal to the measured monitor sampler edge transition value from block 508, flow proceeds to block 514. If the measured main sampler edge transition value from block 502 is not equal to the measured monitor sampler edge transition value from block 508, flow proceeds to block 512. In block 512, a new step size value is selected and set (512). For example, control circuitry 170 may selects and output to DAC 171 a new STEPSZ[] value according to a search algorithm (e.g., increments, decrements, etc. as part of a sweep or other search algorithm for STEPSZ[]). After control circuitry 170 may selects and output to DAC 171 a new STEPSZ[] value, flow proceeds back to block 508 to measure a new (a monitor sampler edge transition value using the current (new) STEPSZ[] value.

In block 514, the current step size value is associated with the current gain setting (514). For example, control circuitry 170 may store a mapping table that associates STEPSZ[] values with GAIN settings. This mapping table may be used, for example, by integrated circuit 100 to select STEPSZ[] values based on the current GAIN setting. If there are no unassociated gain settings left, flow ends in box 520. If there are unassociated gain settings, flow proceeds to box 518. In box 518, a new gain setting is selected and set (518). For example, control circuitry 170 may select and provide a new GAIN indicator to AFE circuitry 151 and DAC 171, a new GAIN indicator according to a search algorithm (e.g., increments, decrements, etc. as part of a sweep or other search algorithm that covers the GAIN settings/indicators of interest). After a new gain setting is selected and set in box 518, flow proceeds to box 506.

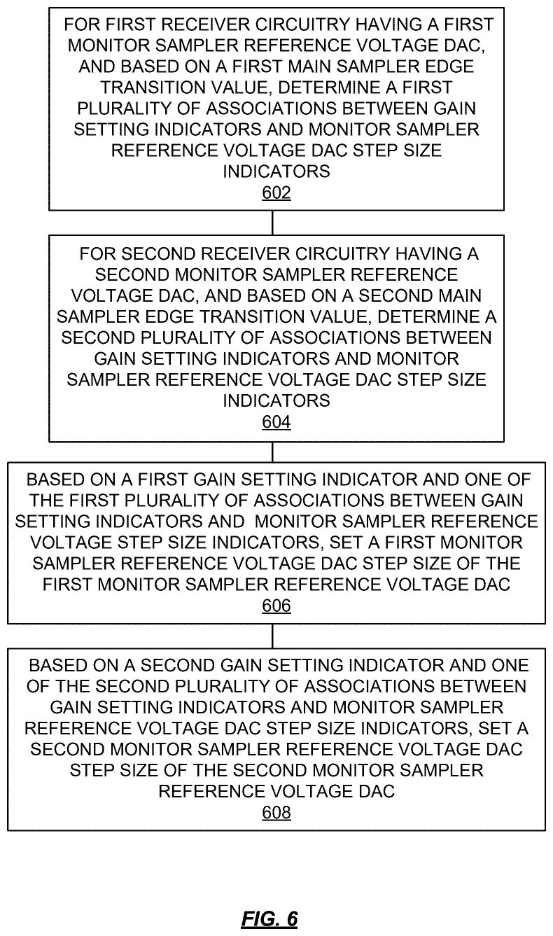

FIG. 6 is a flowchart illustrating a method of setting a plurality of monitor sampler reference voltage digital-to-analog converter set sizes. The steps illustrated in FIG. 6 may be performed by one or more elements of integrated circuit 100, system 200, and/or system 300. For first receiver circuitry having a first monitor sampler reference voltage DAC, and based on a first main sampler edge transition value, a first plurality of associations between gain setting indicators and monitor sampler reference voltage DAC step size indicators are determined (602). For example, control circuitry 170 may search for, and thereby determine, a plurality of step size settings for DAC 171 of receiver circuitry 160 that result in, for each of a given set of GAIN settings, VRVAL[] equaling MVRVAL[].

For second receiver circuitry having a second monitor sampler reference voltage DAC, and based on a second main sampler edge transition value, a second plurality of associations between gain setting indicators and monitor sampler reference voltage DAC step size indicators are determined (604). For example, control circuitry 170 may search for, and thereby determine, a plurality of step size settings for DAC 171 of receiver circuitry 161 that result in, for each of a given set of GAIN settings, VRVAL[] equaling MVRVAL[]. Based on a first gain setting indicator and one of the first plurality of associations between gain setting indicators and monitor sampler reference voltage step size indicators, a first monitor sampler reference voltage DAC step size of the first monitor sampler reference voltage DAC is set (606). For example, control circuitry 170 may, set STEPSZ[] to the one of the plurality of step size settings for DAC 171 of receiver circuitry 160 that result in, for the current GAIN setting being used by receiver circuitry 160, VRVAL[] equaling MVRVAL[].

Based on a second gain setting indicator and one of the second plurality of associations between gain setting indicators and monitor sampler reference voltage DAC step size indicators, second monitor sampler reference voltage DAC step size of the second monitor sampler reference voltage DAC is set (608). For example, control circuitry 170 may, set STEPSZ[] to the one of the plurality of step size settings for DAC 171 of receiver circuitry 161 that result in, for the current GAIN setting being used by receiver circuitry 161, VRVAL[] equaling MVRVAL[].

The methods, systems and devices described above may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of integrated circuit 100, system 200, and/or system 300 and their components. These software descriptions may be: behavioral, register transfer, logic component, transistor, and layout geometry-level descriptions. Moreover, the software descriptions may be stored on storage media or communicated by carrier waves.

Data formats in which such descriptions may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email. Note that physical files may be implemented on machine-readable media such as: 4 mm magnetic tape, 8 mm magnetic tape, 3½ inch floppy media, CDs, DVDs, and so on.

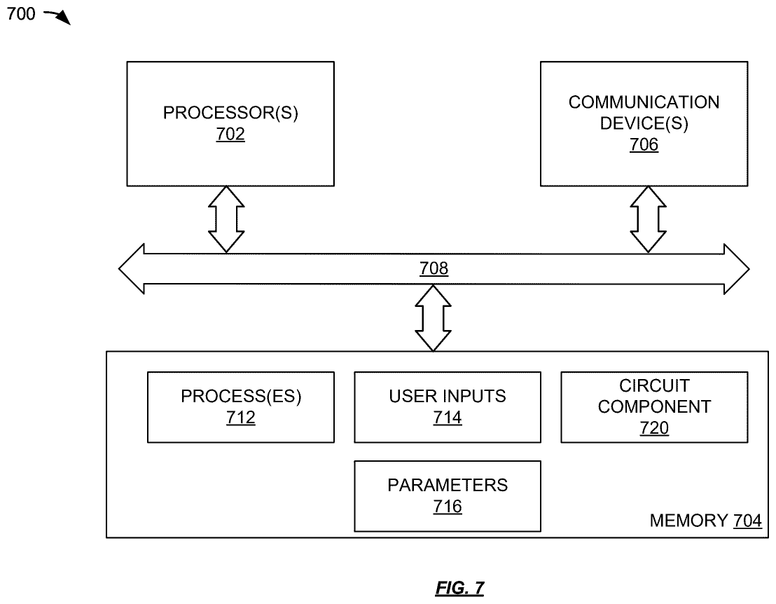

FIG. 7 is a block diagram illustrating one embodiment of a processing system 700 for including, processing, or generating, a representation of a circuit component 720. Processing system 700 includes one or more processors 702, a memory 704, and one or more communications devices 706. Processors 702, memory 704, and communications devices 706 communicate using any suitable type, number, and/or configuration of wired and/or wireless connections 708.

Processors 702 execute instructions of one or more processes 712 stored in a memory 704 to process and/or generate circuit component 720 responsive to user inputs 714 and parameters 716. Processes 712 may be any suitable electronic design automation (EDA) tool or portion thereof used to design, simulate, analyze, and/or verify electronic circuitry and/or generate photomasks for electronic circuitry. Representation 720 includes data that describes all or portions of integrated circuit 100, system 200, and/or system 300, and their components, as shown in the Figures.

Representation 720 may include one or more of behavioral, register transfer, logic component, transistor, and layout geometry-level descriptions. Moreover, representation 720 may be stored on storage media or communicated by carrier waves.

Data formats in which representation 720 may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email.

User inputs 714 may comprise input parameters from a keyboard, mouse, voice recognition interface, microphone and speakers, graphical display, touch screen, or other type of user interface device. This user interface may be distributed among multiple interface devices. Parameters 716 may include specifications and/or characteristics that are input to help define representation 720. For example, parameters 716 may include information that defines device types (e.g., NFET, PFET, etc.), topology (e.g., block diagrams, circuit descriptions, schematics, etc.), and/or device descriptions (e.g., device properties, device dimensions, power supply voltages, simulation temperatures, simulation models, etc.).

Memory 704 includes any suitable type, number, and/or configuration of non-transitory computer-readable storage media that stores processes 712, user inputs 714, parameters 716, and circuit component 720.

Communications devices 706 include any suitable type, number, and/or configuration of wired and/or wireless devices that transmit information from processing system 700 to another processing or storage system (not shown) and/or receive information from another processing or storage system (not shown). For example, communications devices 706 may transmit circuit component 720 to another system. Communications devices 706 may receive processes 712, user inputs 714, parameters 716, and/or circuit component 720 and cause processes 712, user inputs 714, parameters 716, and/or circuit component 720 to be stored in memory 704.

Implementations discussed herein include, but are not limited to, the following examples:
Example 1: An integrated circuit, comprising: receiver circuitry to receive an input signal and comprising analog front-end (AFE) circuitry and decision feedback equalization (DFE) circuitry, the AFE circuitry and the DFE circuitry to collectively generate a summed node signal; monitor circuitry to compare the summed node signal and a monitor threshold signal; and variable step size digital-to-analog converter (DAC) circuitry to generate the monitor threshold signal based on a digital monitor threshold value and a DAC step size indicator.
Example 2: The integrated circuit of example 1, further comprising: control circuitry to sweep the digital monitor threshold value for a plurality of variable step size DACs.
Example 3: The integrated circuit of example 2, further comprising: a common mode error removal DAC to, based on a digital common mode error removal value, generate a voltage threshold signal to be provided to the AFE circuitry.
Example 4: The integrated circuit of example 3, further comprising: a gain indicator to be provided to the AFE circuitry, the variable step size DAC circuitry, and the control circuitry.
Example 5: The integrated circuit of example 4, wherein the AFE circuitry comprises differential amplifier circuitry to amplify a first difference between the input signal and the voltage threshold signal.
Example 6: The integrated circuit of example 5, wherein a gain of the differential amplifier circuitry is to be based on the gain indicator.
Example 7: The integrated circuit of example 6, wherein the control circuitry is to further sweep the DAC step size indicator for a plurality of variable step size DACs.
Example 8: An integrated circuit, comprising: a plurality of receiver circuits each comprising: receiver circuitry to receive an input signal and comprising analog front-end (AFE) circuitry and decision feedback equalization (DFE) circuitry, the AFE circuitry and the DFE circuitry to collectively generate a summed node signal; monitor circuitry to compare the summed node signal and a monitor threshold signal; and variable step size digital-to-analog converter (DAC) circuitry to generate the monitor threshold signal based on a gain indicator and a DAC step size indicator; and control circuitry to, for each of the plurality of receiver circuits, determine respective relations between a plurality of gain indicators and a plurality of DAC steps size indicators.
Example 9: The integrated circuit of example 8, wherein the control circuitry is to receive the gain indicator.
Example 10: The integrated circuit of example 9, wherein the AFE circuitry of each of the plurality of receiver circuits is to receive the gain indicator.
Example 11: The integrated circuit of example 10, wherein the variable step size DAC circuitry of each of the plurality of receiver circuits is to receive the gain indicator.
Example 12: The integrated circuit of example 11, wherein each of the plurality of receiver circuits further comprise: a voltage threshold DAC to generate a voltage threshold signal that is provided to the AFE circuitry.
Example 13: The integrated circuit of example 12, wherein the AFE circuitry of each of the plurality of receiver circuits comprises: differential amplifier circuitry to amplify a difference between a respective input signal and a respective voltage threshold signal.
Example 14: The integrated circuit of example 13, wherein a respective gain of the differential amplifier circuitry of each of the plurality of receiver circuits is based on the gain indicator.
Example 15: A method of operating an integrated circuit, comprising: receiving, by receiver circuitry comprising analog front-end (AFE) circuitry and decision feedback equalization (DFE) circuitry, an input signal; collectively generating, by the AFE circuitry and the DFE circuitry, a summed node signal; comparing the summed node signal and a monitor threshold signal; and generating the monitor threshold signal based on a digital monitor threshold value and a DAC step size indicator.
Example 16: The method of example 15, further comprising: respectively sweeping the digital monitor threshold value for a plurality of variable step size DACs.
Example 17: The method of example 16, further comprising: based on a digital common mode error removal value, generating a voltage threshold signal; and providing the voltage threshold signal to the AFE circuitry.
Example 18: The method of example 17, further comprising: providing a gain indicator to the AFE circuitry.
Example 19: The method of example 18, further comprising: amplifying a first difference between the input signal and the voltage threshold signal.
Example 20: The method of example 19, wherein an amount of amplification of the first difference is based on the gain indicator.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. An integrated circuit, comprising:
receiver circuitry to receive an input signal and comprising analog front-end (AFE) circuitry and decision feedback equalization (DFE) circuitry, the AFE circuitry and the DFE circuitry to collectively generate a summed node signal;
monitor circuitry to compare the summed node signal and a monitor threshold signal; and
variable step size digital-to-analog converter (DAC) circuitry to generate the monitor threshold signal based on a digital monitor threshold value and a DAC step size indicator.

2. The integrated circuit of claim 1, further comprising:
control circuitry to sweep the digital monitor threshold value for a plurality of variable step size DACs.

3. The integrated circuit of claim 2, further comprising:
a common mode error removal DAC to, based on a digital common mode error removal value, generate a voltage threshold signal to be provided to the AFE circuitry.

4. The integrated circuit of claim 3, further comprising:
a gain indicator to be provided to the AFE circuitry, the variable step size DAC circuitry, and the control circuitry.

5. The integrated circuit of claim 4, wherein the AFE circuitry comprises differential amplifier circuitry to amplify a first difference between the input signal and the voltage threshold signal.

6. The integrated circuit of claim 5, wherein a gain of the differential amplifier circuitry is to be based on the gain indicator.

7. The integrated circuit of claim 6, wherein the control circuitry is to further sweep the DAC step size indicator for a plurality of variable step size DACs.

8. An integrated circuit, comprising:
a plurality of receiver circuits each comprising:
receiver circuitry to receive an input signal and comprising analog front-end (AFE) circuitry and decision feedback equalization (DFE) circuitry, the AFE circuitry and the DFE circuitry to collectively generate a summed node signal;
monitor circuitry to compare the summed node signal and a monitor threshold signal; and
variable step size digital-to-analog converter (DAC) circuitry to generate the monitor threshold signal based on a gain indicator and a DAC step size indicator; and
control circuitry to, for each of the plurality of receiver circuits, determine respective relations between a plurality of gain indicators and a plurality of DAC steps size indicators.

9. The integrated circuit of claim 8, wherein the control circuitry is to receive the gain indicator.

10. The integrated circuit of claim 9, wherein the AFE circuitry of each of the plurality of receiver circuits is to receive the gain indicator.

11. The integrated circuit of claim 10, wherein the variable step size DAC circuitry of each of the plurality of receiver circuits is to receive the gain indicator.

12. The integrated circuit of claim 11, wherein each of the plurality of receiver circuits further comprise:
a voltage threshold DAC to generate a voltage threshold signal that is provided to the AFE circuitry.

13. The integrated circuit of claim 12, wherein the AFE circuitry of each of the plurality of receiver circuits comprises:
differential amplifier circuitry to amplify a difference between a respective input signal and a respective voltage threshold signal.

14. The integrated circuit of claim 13, wherein a respective gain of the differential amplifier circuitry of each of the plurality of receiver circuits is based on the gain indicator.

15. A method of operating an integrated circuit, comprising:
receiving, by receiver circuitry comprising analog front-end (AFE) circuitry and decision feedback equalization (DFE) circuitry, an input signal;
collectively generating, by the AFE circuitry and the DFE circuitry, a summed node signal;
comparing the summed node signal and a monitor threshold signal; and
generating the monitor threshold signal based on a digital monitor threshold value and a DAC step size indicator.

16. The method of claim 15, further comprising:
respectively sweeping the digital monitor threshold value for a plurality of variable step size DACs.

17. The method of claim 16, further comprising:
based on a digital common mode error removal value, generating a voltage threshold signal; and
providing the voltage threshold signal to the AFE circuitry.

18. The method of claim 17, further comprising:
providing a gain indicator to the AFE circuitry.

19. The method of claim 18, further comprising:
amplifying a first difference between the input signal and the voltage threshold signal.

20. The method of claim 19, wherein an amount of amplification of the first difference is based on the gain indicator.
